(19) United States
(12) Patent Application Publication
(10) Pub. No.: US 2021/0217399 A1
(43) Pub. Date: Jul. 15, 2021

(54) NOISE REDUCTION DEVICE AND METHOD BASED ON MULTI-SOUND PRODUCTION UNITS THEREOF

(71) Applicant: Shenzhen Ginto E-Commerce Co., Limited, Shenzhen (CN)

(72) Inventors: Jianhua HUANG, Shenzhen (CN); Jin YANG, Shenzhen (CN)

(21) Appl. No.: 16/745,397

(22) Filed: Jan. 17, 2020

(30) Foreign Application Priority Data
Jan. 10, 2020 (CN) 202010027004.4

(51) Int. Cl. G10K 11/178; H04R 1/10

(52) U.S. Cl. CPC G10K 11/17827; H04R 1/1083; G10K 2210/1081; G10K 11/17873; G10K 11/17885

(57) ABSTRACT

A noise reduction device and a method based on multi-sound production units thereof includes an audio processing chip, a power source configured to supply power to the audio processing chip, a microphone configured to collect environmental noise signals, a first sound production unit and a second sound production unit at least provided and configured to produce sound by an electro-acoustic conversion. The power source, the microphone, the first and second sound production units are electrically connected to the audio processing chip. The audio processing chip is configured to receive the environmental noise signals collected by the microphone and then output a reverse noise counteracted the environmental noise via the first sound production unit, and further configured to receive an input audio signal to be played and then output via the second sound production unit. The present disclosure can reduce noise without losing details of audio signals and ensure audio quality.

### BACKGROUND

### 1. Technical Field

The present disclosure generally relates to acoustics noise reduction devices field, and especially relates to a noise reduction device and a method based on multi-sound production units thereof.

### 2. Description of Related Art

An acoustic principle of a noise reduction technology is to counteract noise by a reverse noise sound wave through a principle of a phase reversal cancellation of a sound wave.

A conventional noise reduction technology is mostly used for noise reduction of earphones and cars, specifically: through the earphones/cars, some of external noise can be first physically isolated, which is called as a passive noise reduction. At the same time, the external noise can also be collected and then converted into electrical signals by a microphone, and then the electrical signals can be processed and converted into anti-phase electrical signals by a DSP chip to form reverse noise signals, finally the reverse noise signals can be played together with audio signals (music, radio, telephone voice, etc.) through a speaker.

However, a disadvantage of the conventional noise reduction technology is that the reverse noise and the audio are produced from a same sound production unit (speaker), so that a part of original noise reduction waves is counteracted audio signals of the audio, rather than counteracted noise signals, thereby the audio signals heard is lost details. In addition, since a frequency response curve of a noise reduction horn should be adjusted to be very straight in order to accurately restore the noise signal. In this way, the audio signal is too common to enhance or weaken performances of different frequencies according to a tuner's preference, which is lack of musicality.

Therefore, an improve noise reduction device and a method thereof to overcome problems mentioned above is needed.

### SUMMARY

The technical problems to be solved: in view of the shortcomings of the related art, the present disclosure relates to a noise reduction device and a method based on multi-sound production units thereof which can reduce noise without losing details of audio signals and ensure audio quality.

The technical solution adopted for solving technical problems of the present disclosure is:

On the one hand, a noise reduction device based on multi-sound production units thereof of the present disclosure is provided and includes an audio processing chip, a power source, a microphone, a first sound production unit and a second sound production unit at least provided;

all the power source, the microphone, the first sound production unit and the second sound production unit are electrically connected to the audio processing chip, the power source configured to supply power to the audio processing chip, the microphone configured to collect environmental noise signals, and both the first sound production unit and the second sound production unit configured to produce sound by an electro-acoustic conversion way;

the audio processing chip is configured to receive the environmental noise signals collected by the microphone and then output a reverse noise counteracted the environmental noise via the first sound production unit; and

the audio processing chip is further configured to receive an input audio signal to be played and then output the input audio signal to be played via the second sound production unit.

Wherein the audio processing chip is an integrated Bluetooth audio processing chip configured to wirelessly receive the input audio signal to be played via a Bluetooth.

Wherein a model of the Bluetooth audio processing chip is BES2300.

Wherein the power source includes a lithium battery, a battery management circuit, a charging interface and a voltage stabilizing circuit; all the lithium battery, the charging interface and the voltage stabilizing circuit electrically connected to the battery management circuit, and both the voltage stabilizing circuit and the battery management circuit electrically connected to the audio processing chip; an external power supply input into the battery management circuit from the charging interface, and then input to charge the lithium battery; and electric energy of the lithium battery output to the voltage stabilizing circuit via the battery management circuit, and then supplied power to the audio processing chip.

Wherein the battery management circuit includes a front-end protection chip with a HP2601D8 model thereof electrically connected to the charging interface, a charging and discharging management chip with a HP4059D6 model thereof electrically connected to both the front-end protection chip and the lithium battery, and a battery protection chip with a XB6091ISC model thereof electrically connected to the lithium battery.

Wherein there are two microphones including a talk microphone electrically connected to the audio processing chip and an active noise reduction microphone.

Wherein each of the first sound production unit and the second sound production unit can be selected from a moving coil unit and a moving iron unit.

On the other hand, a noise reduction method of the present disclosure applied to the noise reduction device, including:

collecting, by the audio processing chip, an input audio signal to be played and environmental noise signals collected by the microphone;

producing, by the audio processing chip, a reverse noise counteracted an environmental noise, according to the environmental noise signals, and then outputting a reverse noise via the first sound production unit; and

outputting, by the audio processing chip, the input audio signal to be played via the second sound production unit.

The present disclosure provides the advantages as below.

The structure of the present disclosure is provided at least two sound production units so that a reverse noise and an audio to be played can be respectively output from the two independent sound production units. In this way, the reverse noise generated by the audio processing chip to counteract the environmental noise can't be interfered with the audio to be played, thereby it can ensure to reduce noise without damaging details of audio signals, so as to obtain pure audio and ensure audio quality. At the same time, the reverse noise and the audio to be played can be independently output so that users can adjust a frequency response curve of the sound production unit according to his own preference, for example, enhancing or weakening sound performances of different frequency bands so as to enhance musicality of the noise reduction device in a process of playing audio and improve uses' experience.

### BRIEF DESCRIPTION OF THE DRAWINGS

In order to more clearly understand the technical solution hereinafter in embodiments of the present disclosure, a brief description to the drawings used in detailed description of embodiments hereinafter is provided thereof. Obviously, the drawings described below are some embodiments of the present disclosure, for one of ordinary skill in the related art, other drawings can be obtained according to the drawings below on the premise of no creative work.

FIG. 1 is a flow chart of a noise reduction device based on multi-sound production units thereof in accordance with an embodiment of the present disclosure;

FIG. 2 is a circuit diagram of an audio processing chip of the noise reduction device of FIG. 1;

FIG. 3 is a circuit diagram of a first sound production unit of the noise reduction device of FIG. 1;

FIG. 4 is a circuit diagram of a second sound production unit of the noise reduction device of FIG. 1;

FIG. 5 is a flow chart of a power source of the noise reduction device of FIG. 1;

FIG. 6 is a circuit diagram of the power source of the noise reduction device of FIG. 5;

FIG. 7 is a circuit diagram of a microphone of the noise reduction device of FIG. 1.

The element labels according to the exemplary embodiment of the present disclosure shown as below:
noise reduction device based on multi-sound production units thereof 100, audio processing chip 10, power source 20, lithium battery 21, battery management circuit 22, front-end protection chip 221, charging and discharging management chip 222, battery protection chip 223, charging interface 23, voltage stabilizing circuit 24, microphone 30, talk microphone 31, active noise control microphone 32, first sound production unit 40, second sound production unit 50.

### DETAILED DESCRIPTION

Reference will now be made in detail to embodiments, examples of which are illustrated in the accompanying drawings. In the following detailed description, numerous specific details are set forth in order to provide a thorough understanding of the subject matter presented herein. Obviously, the implementation embodiment in the description is a part of the present disclosure implementation examples, rather than the implementation of all embodiments, examples. According to the described embodiment of the present disclosure, all other embodiments obtained by one of ordinary skill in the related art on the premise of no creative work are within the protection scope of the present disclosure.

In the description of the present disclosure, it needs to be explained that all the directional indicators (such as the terms: “upper”, “below”, “left”, “right”, “front”, “back” . . . ), are shown in the specification of the present disclosure. The indicated orientation or position of the terms shown in the detailed description is based on the orientation or position shown in the figures of the accompanying drawings of the present disclosure, which is only to easily simplify the description of the present disclosure, but not indicated that the devices or elements of the present disclosure should have a particular orientation or should be designed and operated in a particular orientation. So the terms illustrated in the detail description are not by way of the limitation of the present disclosure.

In the description of the present disclosure, except where specifically otherwise illustrated or limited, the terms “connect” and “link” used herein should be understood in a broad sense. Such as, the meaning may be tight connection, removable connection, or integrated connection. The meaning may also be mechanical connection, electrical connection, direct connection or indirect connection through intermediaries, or internal connection within two elements. The meaning of the terms used herein may be understood by one of ordinary skill in the related art according to specific conditions of the present disclosure.

Furthermore, in the description of the present disclosure, the terms such as “first” and “second” shown in the specification are only used to describe, but not indicated that the elements of the present disclosure is important or represented the amount of the elements. That is, the features limited by the terms of “first” and “second” may explicitly or implicitly include one or more features.

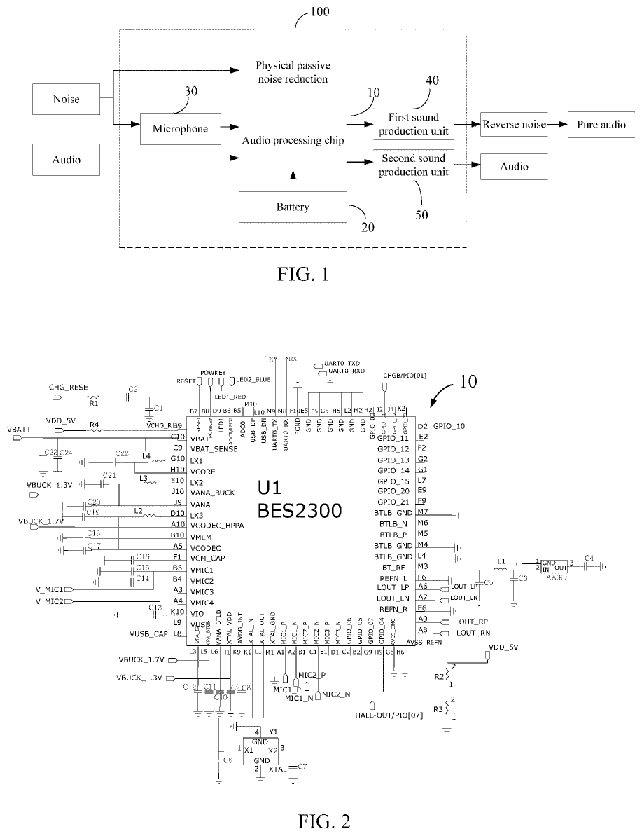

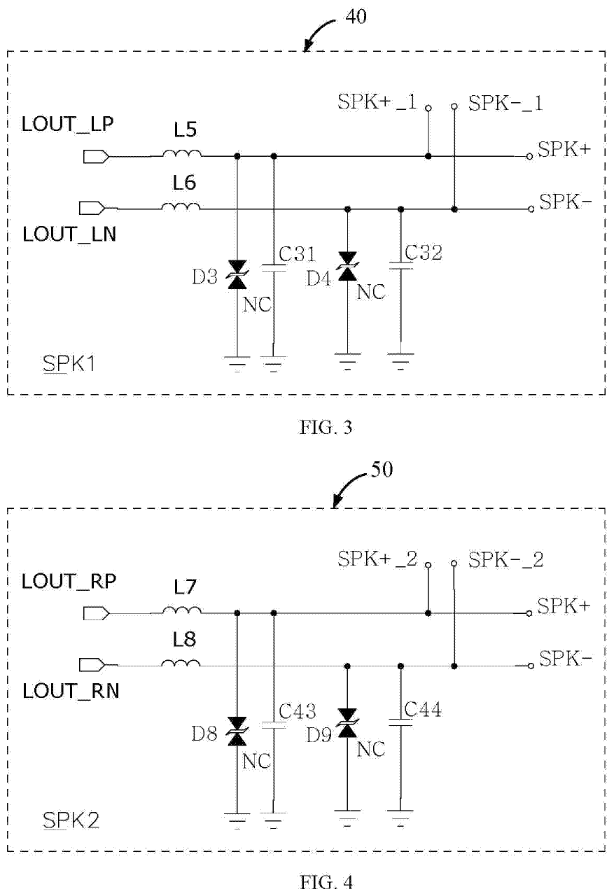

Referring to FIG. 1 and FIG. 2, a noise reduction device 100 based on multi-sound production units thereof in accordance with an embodiment of the present disclosure includes an audio processing chip 10, a power source 20, a microphone 30, a first sound production unit 40 and a second sound production unit 50 at least provided. The noise reduction device 100 of the present disclosure can be a headset with a noise reduction function and an electronic device such as an automobile.

All of the power source 20, the microphone 30, the first sound production unit 40 and the second sound production unit 50 are electrically connected to the audio processing chip 10. The power source 20 is configured to supply power to the audio processing chip 10, the microphone 30 is configured to collect environmental noise signals, and both the first sound production unit 40 and the second sound production unit 50 are configured to produce sound by an electro-acoustic conversion way.

The audio processing chip 10 is configured to receive the environmental noise signals collected by the microphone 30 and then output a reverse noise counteracted the environmental noise via the first sound production unit 40. The microphone 30 is configured to collect the environmental noise and then convert the environmental noise into an electrical signal. The electrical signal is converted by the audio processing chip 10 into an anti-phase electrical signal to form a reverse noise, and then is output to be played by the first sound production unit 40, which can be counteracted the environmental noise after a passive noise reduction to achieve a good noise reduction effect.

At the same time, the audio processing chip 10 of the present disclosure is further configured to receive an input audio signal to be played and output the input audio signal to be played via the second sound production unit 50. A normal audio signal to be played is input into the audio processing chip 10 and then output to be played via the second sound production unit 50. Because the audio signal to be played and the reverse noise are output by their respective sound production units, the reverse noise generated by the audio processing chip 10 to counteract the environmental noise can't be interfered with the audio to be played. In this way, details of the audio signal can't be damaged so that the noise reduction device 100 can finally output pure audio, thus ensuring good quality of an original input audio. At the same time, since the reverse noise and the audio to be played are respectively output from independent sound production units, compared with the conventional technology that only one sound production unit is configured to output both the reverse noise and the audio to be played, which is impossible to adjust the frequency response curve of the audio playback alone. The frequency response curve of the second sound production unit 50 can be adjusted by the noise reduction device 100 according to a user's own preference, rather than interfering with the frequency response curve of the first sound production unit 40, so as to improve a music performance and the use's experience.

Preferably, the first sound production unit 40 of the present disclosure can be a moving coil unit or a moving iron unit; at the same time, the second sound production unit 50 of the present disclosure can also be a moving coil unit or a moving iron unit. That is, both the first sound production unit 40 and the second sound production unit 50 of the present disclosure can be simultaneously set as a moving coil unit or a moving iron unit or a combination of a moving coil unit and a moving iron unit to meet different sound quality requirements.

The audio processing chip 10 of the present disclosure can be a DSP digital processing chip configured to convert an analog signal of the environmental noise collected by the microphone 30 into a digital signal and then convert the digital signal into a reverse noise with an anti-phase.

Preferably, the audio processing chip 10 of the present disclosure is an integrated Bluetooth audio processing chip configured to wirelessly receive the input audio signal to be played via a Bluetooth. In this way, a normal audio to be played can be transmitted to the noise reduction device 100 of the present disclosure by means of a Bluetooth, which is very convenient for promotion and application to a Bluetooth headset.

Referring to FIGS. 2-4, in an embodiment of the present disclosure, a model of the Bluetooth audio processing chip is BES2300.

The BES2300 chip can support a Bluetooth 5.0, a LBRT low-frequency forwarding technology and a dual-mode Bluetooth 5.0, and also support a third-generation full wireless stereo (FWS) technology and dual microphones, etc, which is packaged by a BGA package with a 28 nm length. It can support a noise reduction technology, especially a high performance adaptive active noise reduction technology so that a high-end active noise reduction headset with a fully integrated chip can be used to achieve a high sound quality and an active noise reduction function.

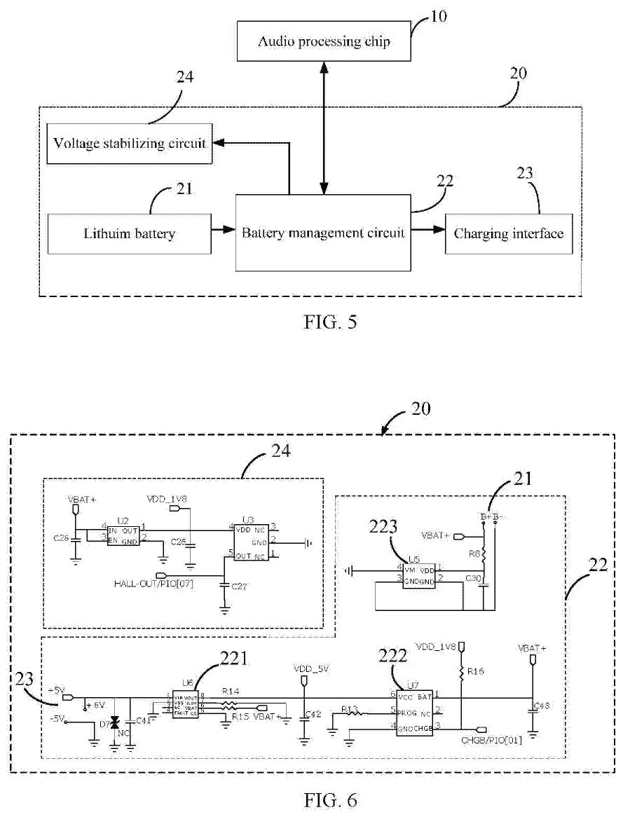

Referring to FIG. 3 and FIG. 4, in an embodiment of the present disclosure, both a LOUT_LP pin and a LOUT_LN pin of the BES2300 chip are respectively connected to a LOUT_LP input terminal and a LOUT_LN input terminal of the first sound production unit 40 (SPK1). Both a LOUT_RP pin and a LOUT_RN pin of the BES2300 chip are respectively connected to a LOUT_RP input terminal and a LOUT_RN input terminal of the second sound production unit 50 (SPK2).

Referring to FIGS. 5-7, the power source 20 of the present disclosure includes a lithium battery 21, a battery management circuit 22, a charging interface 23 and a voltage stabilizing circuit 24. All the lithium battery 21, the charging interface 23 and the voltage stabilizing circuit 24 are electrically connected to the battery management circuit 22, and both the voltage stabilizing circuit 24 and the battery management circuit 22 are electrically connected to the audio processing chip 10. An external power supply is input into the battery management circuit 22 from the charging interface 23, and then input to charge the lithium battery 21, and then electric energy of the lithium battery 21 is output to the voltage stabilizing circuit 24 via the battery management circuit 22, and then is supplied power to the audio processing chip 10. The battery management circuit 22 is configured to manage and protect of charging and discharging the lithium battery 21, while the voltage stabilizing circuit 24 is configured to provide a stable voltage for the audio processing chip 10 to ensure a normal operation of the whole noise reduction device 100. In an embodiment of the present disclosure, the voltage stabilizing circuit 24 includes a pair of voltage stabilizing chips U2, U3. A model of the voltage stabilizing chip U2 is RS3236, and a model of the voltage stabilizing chip U3 is AS1510. An OUT pin of the voltage stabilizing chip U3 is connected to a HALL-OUT/PLO [07] terminal of the BES2300 chip to supply power for the BES2300 chip.

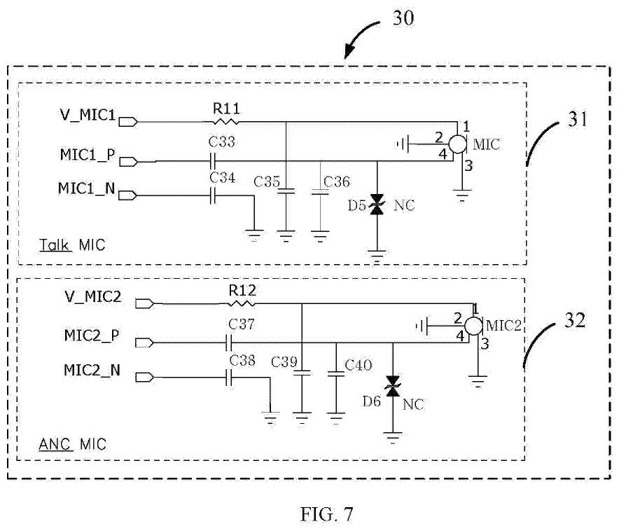

Furthermore, referring to FIG. 6, the battery management circuit 22 of the present disclosure includes a front-end protection chip 221 (U6) electrically connected to the charging interface 23, a charging and discharging management chip 222 (U7) electrically connected to both the front-end protection chip 221 (U6) and the lithium battery 21, and a battery protection chip 223 (U5) electrically connected to the lithium battery 21. A model of the front-end protection chip 221 (U6) is HP2601D8, a model of the charging and discharging management chip 222 (U7) is HP4059D6, and a model of the battery protection chip 223 (U5) is HX6091ISC. The front-end protection chip 221 (U6) is configured to provide current limiting protection, the charging and discharging management chip 222 (U7) is configured to control to charge and discharge the lithium battery 21, and the battery protection chip 223 (U5) is configured to protect the lithium battery 21 from an over-charge, an over-discharge, an over-current, an over-heat and a short circuit. In this way, the lithium battery 21 of the present disclosure can be well protected so that an improved service life of a product can be obtained.

Preferably, referring to FIG. 7, the noise reduction device 100 of the present disclosure includes two microphones 30 which include a talk microphone (Talk MIC) 31 electrically connected to the audio processing chip 10 and an active noise reduction microphone 32 (ANC MIC). The talk microphone 31 is configured to collect a normal audio, and the active noise reduction microphone 32 is configured to actively monitor the environmental noise and feedback the environmental noise to the audio processing chip 10 in time for noise reduction so as to improve a good noise reduction effect.

A noise reduction method based on multi-sound production units thereof of the present disclosure is also provided to be applied on the noise reduction device mentioned above. The noise reduction method includes:

collecting, by the audio processing chip 10, an input audio signal to be played and environmental noise signals collected by the microphone 30;

producing, by the audio processing chip 10, a reverse noise counteracted an environmental noise, according to the environmental noise signals, and then outputting the reverse noise via the first sound production unit 40; and

outputting, by the audio processing chip 10, the input audio signal to be played via the second sound production unit 50.

In this way, the noise reduction method based on multi-sound production units thereof of the present disclosure can ensure that the reverse noise and an audio to be played are respectively output from the two independent sound production units. Therefore, the reverse noise counteracted the environmental noise can't be interfered with the audio to be played to ensure audio quality.

The noise reduction device 100 and a method based on multi-sound production units thereof of the present disclosure are provided at least two sound production units so that a reverse noise and an audio to be played can be respectively output from the two independent sound production units. In this way, the reverse noise generated by the audio processing chip 10 to counteract the environmental noise can't be interfered with the audio to be played, thereby it can ensure to reduce noise without damaging details of audio signals, so as to obtain pure audio and ensure audio quality. At the same time, the reverse noise and the audio to be played can be independently output so that users can adjust a frequency response curve of the sound production unit according to his own preference, for example, enhancing or weakening sound performances of different frequency bands so as to enhance musicality of the noise reduction device in a process of playing audio and improve uses' experience.

Although the features and elements of the present disclosure are described as embodiments in particular combinations, each feature or element can be used alone or in other various combinations within the principles of the present disclosure to the full extent indicated by the broad general meaning of the terms in which the appended claims are expressed.

What is claimed is:

1. A noise reduction device based on multi-sound production units thereof comprising:
an audio processing chip;
a microphone electrically connected to the audio processing chip and configured to collect environmental noise signals;
a power source electrically connected to the audio processing chip and supplying power to the audio processing chip;
a first sound production unit and a second sound production unit at least provided and electrically connected to the audio processing chip, respectively, and configured to produce sound by an electro-acoustic conversion way; and
wherein
the audio processing chip is configured to receive the environmental noise signals collected by the microphone and then output a reverse noise counteracted the environmental noise via the first sound production unit, and further configured to receive an input audio signal to be played and then output the input audio signal to be played via the second sound production unit.

2. The noise reduction device as claimed in claim 1, wherein the audio processing chip is an integrated Bluetooth audio processing chip configured to wirelessly receive the input audio signal to be played via a Bluetooth.

3. The noise reduction device as claimed in claim 2, wherein a model of the Bluetooth audio processing chip is BES2300.

4. The noise reduction device as claimed in claim 1, wherein the power source comprises a lithium battery, a battery management circuit, a charging interface and a voltage stabilizing circuit; all of the lithium battery, the charging interface and the voltage stabilizing circuit electrically connected to the battery management circuit, and both the voltage stabilizing circuit and the battery management circuit electrically connected to the audio processing chip; an external power supply input into the battery management circuit from the charging interface, and then input to charge the lithium battery; and electric energy of the lithium battery output to the voltage stabilizing circuit via the battery management circuit, and then supplied power to the audio processing chip.

5. The noise reduction device as claimed in claim 4, wherein the battery management circuit comprises a front-end protection chip with a HP2601D8 model thereof electrically connected to the charging interface, a charging and discharging management chip with a HP4059D6 model thereof electrically connected to both the front-end protection chip and the lithium battery, and a battery protection chip with a XB6091ISC model thereof electrically connected to the lithium battery.

6. The noise reduction device as claimed in claim 1, wherein there are two microphones comprising a talk microphone electrically connected to the audio processing chip and an active noise reduction microphone.

7. The noise reduction device as claimed in claim 1, wherein each of the first sound production unit and the second sound production unit can be selected from a moving coil unit and a moving iron unit.

8. A noise reduction method based on multi-sound production units thereof comprising:
providing an audio processing chip, a microphone electrically connected to the audio processing chip and configured to collect environmental noise signals, a power source electrically connected to the audio processing chip and supplying power to the audio processing chip, and a first sound production unit and a second sound production unit at least provided and electrically connected to the audio processing chip, respectively, and configured to produce sound by an electro-acoustic conversion way;
collecting, by the audio processing chip, an input audio signal to be played and the environmental noise signals collected by the microphone;
producing, by the audio processing chip, a reverse noise counteracted an environmental noise, according to the environmental noise signals, and then outputting the reverse noise via the first sound production unit; and
outputting, by the audio processing chip, the input audio signal to be played via the second sound production unit.

9. The noise reduction method as claimed in claim 8, wherein the audio processing chip is an integrated Bluetooth audio processing chip to wirelessly receive the input audio signal to be played via a Bluetooth.

10. The noise reduction method as claimed in claim 9, wherein a model of the Bluetooth audio processing chip is BES2300.

11. The noise reduction method as claimed in claim 8, wherein the power source comprises a lithium battery, a battery management circuit, a charging interface and a voltage stabilizing circuit; all the lithium battery, the charging interface and the voltage stabilizing circuit electrically connected to the battery management circuit, and both the voltage stabilizing circuit and the battery management circuit electrically connected to the audio processing chip; an external power supply input into the battery management circuit from the charging interface, and then input to charge the lithium battery; and electric energy of the lithium battery output to the voltage stabilizing circuit via the battery management circuit, and then supplied power to the audio processing chip.

12. The noise reduction method as claimed in claim 11, wherein the battery management circuit comprises a front-end protection chip with a HP2601D8 model thereof electrically connected to the charging interface, a charging and discharging management chip with a HP4059D6 model thereof electrically connected to both the front-end protection chip and the lithium battery, and a battery protection chip with a XB6091ISC model thereof electrically connected to the lithium battery.

13. The noise reduction method as claimed in claim 8, wherein there are two microphones comprising a talk microphone electrically connected to the audio processing chip and an active noise reduction microphone.

14. The speaker monomer as claimed in claim 8, wherein each of the first sound production unit and the second sound production unit can be selected from a moving coil unit and a moving iron unit.
